(19) United States
(12) Patent Application Publication
(10) Pub. No.: US 2007/0203437 A1
(43) Pub. Date: Aug. 30, 2007

(54) Soft tissue massage device

(76) Inventor: John Squillace, Greenwich, CT (US)

Correspondence Address: JAMES RAY & ASSOCIATES, 2640 PITCAIRN ROAD, MONROEVILLE, PA, 15146, US

(21) Appl. No.: 11/652,741

(22) Filed: Jan. 12, 2007

Related U.S. Application Data
(60) Provisional application No. 60/777,410, filed on Feb. 28, 2006.

(51) Int. Cl. A61H 15/00

(52) U.S. Cl. 601/132; 601/118; 601/131

(57) ABSTRACT

A device for massaging soft tissue of an individual when positioned between such soft tissue and a predetermined surface. The massage device includes a spherical member made from a first predetermined material and having each of a first predetermined diameter and a predetermined weight for rolling over such soft tissue. There is a rope member made from a second predetermined material and having each of a second predetermined diameter and a predetermined length. The rope member is connected to the spherical member for encircling a pre-selected body part. Finally, a mechanism is engageable with the rope member for adjusting tightness thereof around such pre-selected body part such that the spherical member is affixed tightly against such soft tissue to be massaged.

### CROSS REFERENCE TO RELATED APPLICATION

This application is closely related to and claims priority from U.S. Provisional Patent Application Ser. No. 60/777,410 filed on Feb. 28, 2006.

### FIELD OF THE INVENTION

The present invention relates, in general, to massage devices and, more particularly, the invention relates to a soft tissue massage device and, still more specifically, the invention relates to a massage device capable of loosening muscle tissue in various areas of the body of an individual to relieve pain, tension, stress, etc. located in those areas.

### BACKGROUND OF THE INVENTION

Prior to the conception and development of the present invention, as is generally well known in the prior art, people have been seeking ways to relieve muscle pain and tightness in various locations of their body at one time or another, especially as they get older.

One such way is thru the use of various nonprescription and prescription pain medications. These medications tend to mask the pain for a predetermined period of time, however, the muscle pain and discomfort will usually come back once the effects of the medicine wear off. In addition, the costs of many medications for temporarily relieving muscle aches and pains can be excessive.

Another alternative people use is seeking assistance from a therapist, massage technician or a chiropractor. However, once again, these visits can be costly and seldom helpful in just one treatment.

### SUMMARY OF THE INVENTION

The present invention provides a device for massaging soft tissue of an individual when positioned between such soft tissue and a predetermined surface. The massage device includes a spherical member made from a first predetermined material and having each of a predetermined circumference and a predetermined weight for rolling over such soft tissue. The massage device also includes a rope member made from a second predetermined material and having each of a predetermined diameter and a predetermined length. The rope member is connected to the spherical member for encircling a pre-selected body part. There is a means engageable with the rope member for adjusting tightness of such rope member around the pre-selected body part such that the spherical member is affixed tightly against such soft tissue to be massaged.

### OBJECTS OF THE INVENTION

It is, therefore, one of the primary objects of the present invention to provide a device for massaging the soft muscle tissue in various areas of an individual to substantially minimize the pain and discomfort located in such soft tissue.

Another object of the present invention is to provide a device that performs a soft tissue massage for pain management as an alternative to taking medications, physical therapy appointments, or adjustments from a chiropractor.

Even another object of the present invention is to provide a soft tissue massage device that can be used while at home, work, or in a car.

Yet another object of the present invention is to provide a soft tissue massage device that is easy to use.

Still another object of the present invention is to provide a soft tissue massage device that is relatively inexpensive.

In addition to the various objects and advantages of the present invention described with some degree of specificity above it should be noted that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of a soft tissue massage device wherein the spherical member has a substantially smooth surface;

FIG. 2 is a perspective view of a soft tissue massage device wherein the spherical member has a pre-selected number of protuberances on its surface; and

FIG. 3 is a perspective view of the soft tissue massage device wherein the spherical member has a pre-selected number of dimples on its surface and is positioned against the back of an individual for use.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

Reference is now made, more particularly, to FIGS. 1-3. Illustrated therein is one presently preferred embodiment of a device, generally designated 10, for massaging soft tissue of an individual 12 when positioned between such soft tissue and a predetermined surface 14. The massage device 10 includes a spherical member 16 made from a first predetermined material and having each of a predetermined circumference and a predetermined weight for rolling over such soft tissue.

The first predetermined material used to make such spherical member 16 is, preferably, an elastomeric material. The elastomeric material is one of plastic, a synthetic rubber and a natural rubber. The predetermined circumference of such spherical member 16 is generally about 22.5 centimeters, and the predetermined weight thereof is generally between about 140 grams and 150 grams.

There is a rope member 18 made from a second predetermined material and having each of a predetermined diameter and a predetermined length. Such rope member 18 is connected to the spherical member 16 for encircling a pre-selected body part of the individual 12.

The predetermined diameter of such rope member 18 is generally about 1.5 centimeters, and the predetermined length thereof is generally about 152 centimeters. Each end of the rope member 18 is connected to the spherical member 16 such that the predetermined length of generally about 152 centimeters is halved to generally about 76 centimeters when rope member 18 is stretched away from such spherical member 16.

There is also a means, generally designated 20, engageable with the rope member 18 for adjusting tightness of such rope member 18 around such pre-selected body part such that the spherical member 16 is affixed tightly against such soft tissue to be massaged.

Such means 20 engageable with the rope member 18 for adjusting tightness thereof around such pre-selected body part of individual 12 includes a pushbutton connector pin 22 capable of being adjusted along the predetermined length of such rope member 18.

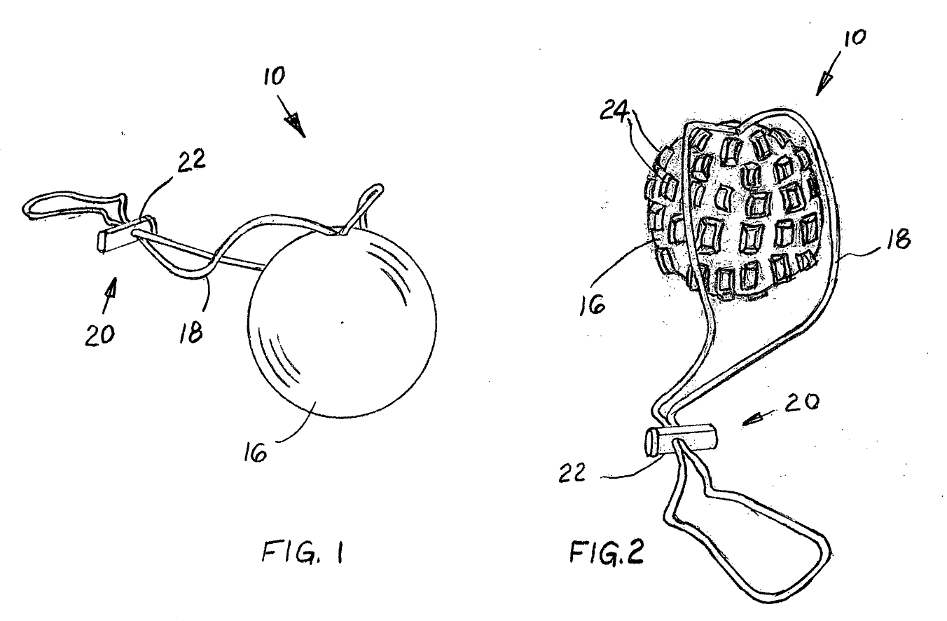

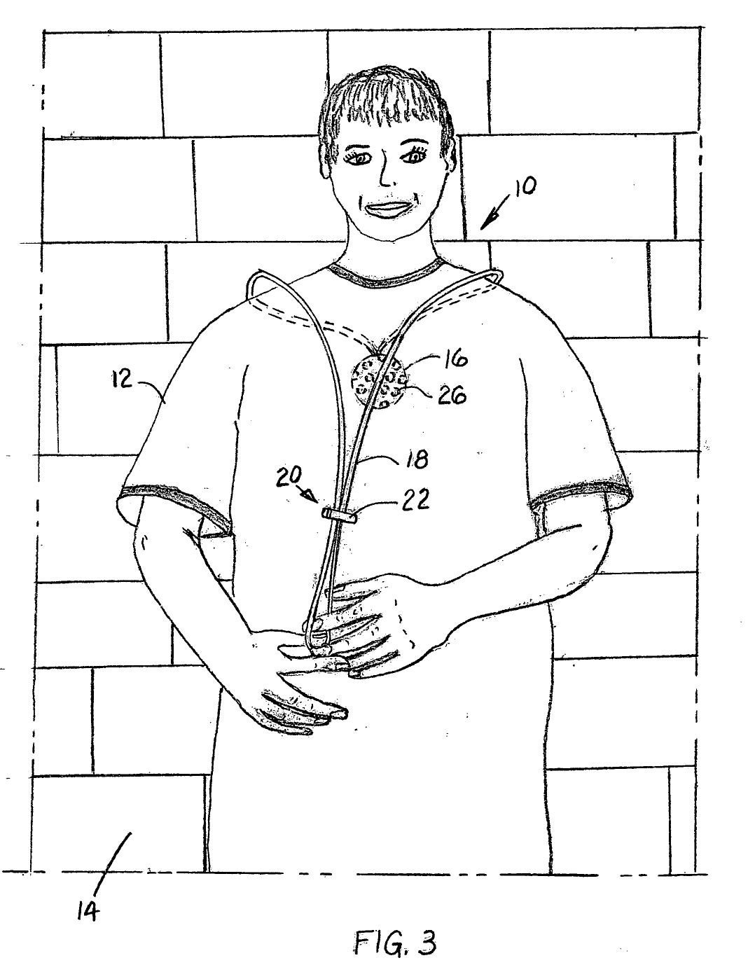

A surface of the spherical member 16 may be substantially smooth as illustrated in FIG. 1, may include a pre-selected number of protuberances 24 thereon as illustrated in FIG. 2, or may include a pre-selected number of dimples 26 thereon as illustrated in FIG. 3. The spherical member 16 of massage device 10 may be manufactured in a wide variety of colors.

To use the massage device 10 the individual 12 simply places the rope member 18 around a convenient area of the body, such as the chest. The spherical member 16 is then placed over the muscle or area that requires a massage. After placing the spherical member 16 between the muscle and a predetermined surface 14, such as a wall, chair, car seat, floor, etc., the individual 12 then moves back and forth, side to side, or uses another method that is comforting. The spherical member 16 will roll over the soft tissue with a desired amount of pressure, loosening muscle tissue and increasing circulation at and around the pain site.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A device for massaging soft tissue of an individual when positioned between such soft tissue and a predetermined surface, said massage device comprising:
(a) a spherical member made from a first predetermined material and having each of a predetermined circumference and a predetermined weight for rolling over such soft tissue;
(b) a rope member made from a second predetermined material and having each of a predetermined diameter and a predetermined length, said rope member connected to said spherical member for encircling a pre-selected body part; and
(c) a means engageable with said rope member for adjusting tightness of said rope member around such pre-selected body part such that said spherical member is affixed tightly against such soft tissue to be massaged.

2. A massage device, according to claim 1, wherein a surface of said spherical member is substantially smooth.

3. A massage device, according to claim 1, wherein a surface of said spherical member includes a pre-selected number of protuberances on an outer surface thereof.

4. A massage device, according to claim 1, wherein a surface of said spherical member includes a pre-selected number of dimples on an outer surface thereof.

5. A massage device, according to claim 1, wherein said spherical member is manufactured in various colors.

6. A massage device, according to claim 1, wherein said first predetermined material used in making said spherical member is an elastomeric material.

7. A massage device, according to claim 6, wherein said elastomeric material is one of plastic, a synthetic rubber and a natural rubber.

8. A massage device, according to claim 7, wherein said elastomeric material is said synthetic rubber.

9. A massage device, according to claim 1, wherein said predetermined circumference of said spherical member is generally about 22.5 centimeters.

10. A massage device, according to claim 1, wherein said predetermined weight of said spherical member is generally between about 140 grams and 150 grams.

11. A massage device, according to claim 1, wherein said predetermined diameter of said rope member is generally about 1.5 centimeters.

12. A massage device, according to claim 1, wherein said predetermined length of said rope member is generally about 152 centimeters.

13. A massage device, according to claim 12, wherein each end of said rope member is connected to said spherical member such that said predetermined length of generally about 152 centimeters is halved to generally about 76 centimeters when said rope member is stretched away from said spherical member.

14. A massage device, according to claim 1, wherein said means engageable with said rope member for adjusting tightness thereof around such pre-selected body part includes a pushbutton connector pin capable of being adjusted along said predetermined length of said rope member.
